(19) United States
(12) Patent Application Publication
(10) Pub. No.: US 2024/0391749 A1
(43) Pub. Date: Nov. 28, 2024

(54) TREATMENT SYSTEM FOR KEGS

(71) Applicant: KHS GmbH, Dortmund (DE)

(72) Inventors: Volker Damerow, Uelversheim (DE); Sebastian Eckes, Langenlonsheim (DE); Maximilian Weindorf, Münsterappel (DE); Christian Pedersen, Kriftel (DE); Manfred Wahl, Oberwiesen (DE); Andreas Weber, Bad Sobernheim (DE); Olaf Muszinski, Bad Soden (DE)

(21) Appl. No.: 18/687,958

(22) PCT Filed: Aug. 30, 2022
(86) PCT No.: PCT/EP2022/074033

§ 371 Date: Feb. 29, 2024

(30) Foreign Application Priority Data
Aug. 31, 2021 (DE) 10 2021 122 440.3

(51) Int. Cl. B67C 3/00; B67C 3/30

(52) U.S. Cl. CPC B67C 3/007; B67C 3/30

(57) ABSTRACT

A system for treating kegs with data carriers. One or more treatment modules, each of which has a keg receiving area, a treatment head, and an one interface for a discharge line and for a cleaning medium line and/or at least one filling product line. A signaling device configured for signaling operations to be carried out with the treatment modules and/or a loading device for supplying and discharging the kegs to and from the treatment modules. A controller configured for controlling the treatment modules, the signaling device, and/or the feed device. A reading device connected to the controller for reading information from the data carriers. The controller being configured to control and/or regulate the treatment of the kegs, in particular a cleaning process and/or a filling process, in the treatment modules based on the information on the data carriers. The information being read by the reading device.

The present invention relates to a system for treating kegs, in particular cleaning and filling. Hitherto, different treatment modules, such as filling modules and cleaning modules, have been arranged for this purpose in a system, where they are loaded and unloaded in a controlled manner by a keg supply and discharge unit. Such a system is described, for example, in WO 2018/059753 A1. With such a system, a large number of kegs can be both filled and cleaned, wherein exterior cleaning modules are also included among the modules of the system and which also allow for an exterior cleaning of the kegs.

In previous keg treatment systems, all the kegs running through the system are treated as single units. That is to say, the duration of treatment and the media consumption is the same for all the kegs. In order to adjust the treatment cycle and/or the treatment duration, a manual selection by the system operator of another treatment programme is required, and, if necessary, re-equipping of the system. The kegs must also be presorted manually by system operators and/or by peripheral machines and, if appropriate, temporarily stored. There is today also the possibility of carrying out sorting operations and sending parts of kegs on “ancillary sections” and returning them to the main flow after treatment.

One problem with such a keg treatment is, for example, the fact that the kegs come back to the filling plant in very varying degrees of dirt contamination. If the cleaning programme is based on very heavily contaminated kegs, long cleaning times are incurred, which impairs the throughput of the system and leads to an unnecessarily high consumption of media. If the cleaning is too short, the risk arises that residues of the previous filling products, or, even worse, dirt residues, may still remain in or on the kegs.

The object of the present invention is to provide a container treatment system which allows for flexible treatment of the kegs, in particular flexible cleaning which corresponds to their degree of dirt contamination.

This object is solved according to the invention by a system according to claim 1. Advantageous embodiments of the invention are objects of the dependent claims. Advantageous embodiments and further developments of the invention are likewise described in the further description or represented in the drawings.

The container treatment system according to the invention for the treatment of kegs provided with data carriers contains the following components: One or more treatment modules, which in each case comprise a keg receiver for receiving at least one keg, a treatment head for treating the keg, and at least one interface for a discharge and for at least one cleaning medium line and/or at least one filling product line. In addition, the system has at least one signalling device for signalling operations to be carried out in conjunction with the treatment modules and/or at least one feed device for supplying and discharging the kegs to/from the individual treatment modules. A controller of the system serves to control the treatment modules and the signalling device and/or the feed device.

According to the invention, the system has a reading device connected to the controller, for reading out the information stored on the data carriers. It is in principle also possible that only access information is held on the data carrier which allows for access to information which is stored on a databank. In addition, the controller is configured such as to control and/or regulate a treatment of the kegs, in particular cleaning and/or filling, in the respective treatment module depending on the information read out by the reading device.

The invention therefore allows the duration and/or intensity and the steps of a treatment to be controlled depending on information which is present on a data carrier which is arranged in conjunction with the keg. Such information can comprise the filling date and the type of the last filling product, the final recipient, address data, etc., and therefore allows the controller to assess which treatment the keg requires in order to ensure optimised cleaning and filling. As a result, the capacity of the system can be much better utilised. No kegs are treated for an unnecessarily long time, and, on the other hand, it is ensured that the kegs have been intensively enough treated for them to be adequately cleaned both inside and/or outside.

In particular, the controller is configured such as to control the duration and/or intensity of the treatment, in particular cleaning and/or filling, by the respective treatment module, depending on the information on the data carriers read out by the reading device, in order in this way to ensure a rapid and effective treatment sequence of the kegs in the system.

Preferably, the controller is a common controller, which is preferably connected in a communicating manner to all the treatment modules as well as to the signalling device and/or the feed device, and is configured such as to control the units connected to it, in particular in a mutually matched and/or process-optimised manner.

The controlling and/or regulating of the treatment of the kegs in the respective treatment module can be carried out depending on the information read out by the reading device (a) by the direct use or (b) by the indirect use of the information read out from the data carriers. In case (a), the information stored on the data carrier itself, or parts thereof, are used for the controlling and/or regulating of the treatment. In case (b), it is possible, for example, for a code to be stored as information on the respective data carrier, to which items of information are unambiguously assigned in a databank, and which are used for the controlling and/or regulating of the treatment. Preferably, the reading device in case (b) is configured such as to read out, from the databank, the information assigned in the databank to the code which has been read out, relating for example to a cable-bound or a wireless data connection.

A “filling product” in the meaning of the present invention can be, for example, a beverage, in particular a beverage containing CO₂. For example, the filling product can be beer, a mixed beer beverage, or a carbonated soft drink.

As “cleaning medium”, consideration can be given to all the media which are conventionally used in the sector of the food industry, in particular the beverage industry, in connection with a cleaning process, which are familiar to the person skilled in the art. The cleaning process can comprise several different cleaning steps with different cleaning media, wherein the several cleaning steps are carried out, for example, sequentially or one after another. Preferably, for the cleaning of the kegs at least one alkali comes into consideration as a cleaning medium or as a constituent part of a cleaning medium.

Advantageously, the respective treatment module is configured as a “stand-alone” module, i.e. a treatment module which can be operated independently of the other treatment modules of the system. As a result, with regard to the number of treatment modules, a high degree of flexibility of the system can be achieved, which can be increased or reduced as desired, as well as the number of the treatment modules which are in operation at one particular time.

Preferably, a reading device, or at least a reading unit of the reading device, is arranged at the feed device, wherein the reading device is preferably configured to read out the information stored on the data carriers, while the kegs are transported by means of the feed device to the treatment module(s). In this way, the reading process is integrated into the normal movement sequence during the to/from transporting of the kegs, and requires neither additional space nor additional time for the reading process.

In one advantageous embodiment of the invention, the reading device or at least a reading unit of the reading device is arranged at or in the treatment module. Moreover, with this technical solution the reading process can be integrated both in location as well as in time into the normal treatment of the keg, which is economically advantageous. Preferably, the reading device comprises a number of reading units which corresponds to the number of treatment modules, for reading out the information stored on the data carriers, wherein such a reading unit is arranged at or in the respective treatment module. In this solution, as described heretofore, the integration of the reading process into the “normal” treatment of the keg in the treatment module is possible.

Preferably, the reading device is configured such as to read out the information stored on the data carriers while the kegs are in the treatment modules. In this situation the kegs have defined positions which can advantageously be used by the reading device in order to read out the data carrier specifically with regard to the kegs positioned in the treatment modules. This can in principle relate to a central reading device, which travels past the treatment modules, or decentralised reading units at each treatment module.

In one advantageous further embodiment of the invention, the reading device is configured such as to read out the information stored on the data carriers with the aid of radio waves. This has the advantage that the reading can take place without contact, and that there can be a certain distance interval between the reading device and the data carrier in order to read it out, which simplifies the reading process and makes it insensitive to interference, for example of a mechanical or visual kind, such as dirt.

Preferably, the reading device is configured as a combined writing and reading device, and equipped such as to write information onto the data carriers of the kegs and/or into a databank. In this way, current treatment data can be rapidly written onto the respective data carrier and/or into the databank, such as the customer, filling product, date, cleaning parameters, etc., which can be used at the next cleaning/filling process for optimum treatment controlling.

In one advantageous embodiment of the invention, the reading device is configured such that, after the treatment in the respective treatment module, it can write information provided by the controller onto the data carriers and/or into the databank, and, in particular, it can at least partially overwrite the information previously stored on the data carriers and/or in the databank, such that they can be used at the next cleaning/filling procedure for optimum treatment controlling.

Preferably, the reading device is configured as an RFID reading device, and the data carriers are configured as RFID transponders, which are preferably capable of being partially overwritten, such that product and filling data can be updated at each treatment procedure. Preferably, passive RFID transponders are used, which do not need an independent power supply. Account can be taken of the shorter range of passive transponders in that, in the system, the RFID readers can be moved closer to the data carriers, as has already been described heretofore.

In one advantageous further embodiment of the invention, at least one treatment module, and preferably several or each of the treatment modules, is configured for the cleaning and filling of the kegs, and has a treatment head both for the interior cleaning as well as for the filling of the kegs. As a result, the system is more flexible with regard to its allocation to different treatment steps, such as cleaning and filling, than the prior art. Preferably, several treatment modules, and ideally all the treatment modules, have this capacity of both cleaning a keg and filling it.

In this way, the system is capable of assigning to the different treatment modules different types of treatment work simultaneously, such as cleaning and filling, flexibly and individually. By contrast with the prior art, where the cleaning and filling capacity was determined by the specialised treatment modules, namely filling modules and cleaning modules, in the treatment system according to the invention a completely flexible allocation from 100% cleaning to 100% filling is possible, depending on the actuation of the individual modules. In addition, it is possible for different products to be filled on different treatment modules, and the cleaning time of each keg can be varied depending on its degree of dirt contamination. Preferably, at least one of the treatment modules has a device for exterior cleaning of the kegs. As a result of this, the flexibility of this at least one treatment module is extended to the treatment type of filling, or the two treatment types of filling and interior cleaning are extended to the treatment of exterior cleaning, which increases the flexibility of the system as a whole and makes the provision of separate external cleaning modules superfluous. The treatment modules in the treatment system can therefore preferably be configured as identical.

As an alternative or in addition, it is possible to provide, in addition to the treatment modules, at least one specialised external cleaning module, which is configured only for the cleaning of one or more kegs. It is of course also possible for the exterior cleaning module to be arranged within the access range of the feeding device for the supplying and discharging of kegs to and from the external cleaning module. The feeding device can therefore, as an alternative, load a treatment module for filling and interior cleaning, or an external cleaning module for the exterior cleaning of the keg, wherein the controller can control these container treatment types in an optimum manner.

The exterior cleaning procedure can also be displayed to an operator person by means of the signalling device, if a loading robot is not being used.

Preferably, the keg receiver of the treatment module is configured for the static receiving of the keg, both during the cleaning as well as during the filling, which ensures easy handling.

Preferably, the keg receiver at least at one of the treatment modules, preferably at several or each of the treatment modules, is configured for the receiving of one individual keg. This has the advantage that, specifically with small systems, individual kegs can be filled one after another with different products. The flexibility of such a system is therefore greater than with conventional market solutions, since the type of treatment can be changed with each keg. In particular, provision can be made for each treatment module to comprise exactly one keg receiver for receiving one individual keg. Preferably, the controller comprises as least one data memory for individual data of the keg, which in particular can be read out from a data carrier of the keg by means of the reading device of the system. The controller is then configured such as to control the duration of the treatment, in particular a cleaning cycle and/or filling cycle, in the respective treatment module as a dependency of the individual data. By means of individual data of the keg which is stored there, such as the filling location and the filling product, it is possible, for example, for its degree of dirt contamination to be detected, directly or indirectly. This data can also be used for reference purposes, such as at which customer the keg was last located, the amount of the empty weight, which product was last filled, how long the keg was with the customer, how long it has been transported or stored, etc. By means of this data, it is also possible to derive future conclusions with regard to the degree of dirt contamination, and, by means of the controller, to use this data to adjust and set an individual cleaning time for each keg.

In one advantageous further embodiment of the invention, the controller is configured such as to calculate the delivery and discharge path of each keg, and to carry out the movement of the feed device in accordance with an optimisation criterion. In this way, the entire handling of the kegs in the system can be optimised in accordance with freely selectable optimisation criteria, such as path optimisation, and/or time optimisation and/or energy optimisation.

Preferably, at least one of the treatment modules, and preferably several or all of the treatment modules, comprises an interface with connections to at least two filling product lines, and the controller is configured such as to operate at least one of the treatment modules with a first filling product, and at least one other of the treatment modules with a second filling product. In this way, it is possible for different filling products to be filled on one system with a time overlap, without the treatment modules having to be rearranged or converted.

The possibility of the time-overlapping filling of different filling products on one system leads to greater flexibility, since, during the filling of a product with a lower throughput, it is not the entire system which is engaged with this filling product, and no rearrangement or conversion of the treatment modules for another filling product is necessary.

In one advantageous further embodiment of the invention, the controller is provided with a work plan memory for cleaning and filling orders which are to be carried out, and the controller comprises a computer module which is configured such as to control the treatment modules on the basis of the cleaning and/or filling orders. In this way, the treatment system can reliably process even smaller orders one after another in an optimum manner, wherein the processing can be optimised in respect of handling technology.

The system is therefore well-suited for filling smaller batches of kegs with different products.

Preferably, the computer module of the controller is configured in particular such as to control the treatment modules and the signalling device and/or the feed device in such a way that the processing of orders takes place in accordance with one or more of the following optimisation criteria:
Time optimisation
Optimisation of the filling and/or cleaning capacity
Energy optimisation
Optimisation of the actuation paths of the feed device
Minimisation of the cleaning effort and/or cleaning media consumption.

Preferably, the treatment modules are configured for the treatment of different kegs, wherein at least one of the treatment modules is configured for the treatment of kegs of a first type and/or of a first size, and at least one other of the treatment modules is configured for the treatment of kegs of a second type and/or of a second size. In this way, it is possible not only for different filling products to be treated, but also different keg sizes or keg shapes in the treatment system.

Preferably, the feed device is a loading robot which is controlled by the controller, which loads the different treatment modules with the correct keg types and sizes which have been assigned to them, and can of course also transport them away. For correct insertion into the treatment modules (as a rule, upside down, i.e. with the fitting pointing downwards), the loading robot can preferably also turn the kegs. The loading robot can be, for example, a jointed arm robot, in particular a 5-axis or 6-axis folding arm robot. The loading robot is advantageously configured as movable in such a way and positioned in such a way that the loading robot can deliver the kegs to each of the treatment modules and/or remove them from each of the treatment modules.

Preferably, the controller is configured such as to calculate the delivery and removal path of each keg and to calculate the movement of the loading robot in accordance with an optimisation criterion, among which optimisation criteria are included in particular the path optimisation, time optimisation, and/or energy optimisation, as well as the optimisation of the actuation paths of the loading robot. This therefore serves either to speed up the throughput of the entire treatment system or its energy optimisation, which is possible, for example, without loss of time over shorter path routes.

The information stored on the data carriers or in a databank and used for the controlling/regulating of the treatment modules relates preferably to a state of the keg, such as its age, the time of the last filling, the type of the last product filled, and/or the number of filling and/or cleaning processes carried out previously. For example, previous cleaning processes can be recorded by a data logger, such as duration, temperature, pressure, and any other desired parameters. The information can further relate to the date of the last maintenance of the keg or its fittings, to the manufacturers of the keg and/or of the fitting and/or to storage parameters and times, etc.

Preferably, at least one of the treatment modules contains a heat measuring device, which is configured such as to measure an outer wall temperature of the keg during the filling and/or cleaning of the keg in the treatment module, in order, for example, to detect the degree of filling and/or dirt contamination of a keg.

In one advantageous further embodiment of the invention, each treatment module which is suitable for cleaning has interfaces to a water line/water vapour or steam line, a tension gas line, and lines for CO₂, sterile air, and/or at least one cleaning medium. In this way, all conventional cleaning media can be delivered to each treatment module which are necessary for a thorough internal/external cleaning of the keg.

Preferably, the treatment system contains at least one signalling device for the signalling of activities which are to be carried out in connection with the treatment modules, or their sequence, and the controller is configured such as to control the signalling device. The signalling device can in particular signal in which sequence the treatment modules are to be loaded with kegs.

The signalling device can comprise a display, a visual device such as an LED, and/or an audible device, such as a loudspeaker, a buzzer, or the like. The signalling device can also be a server-based terminal. The signalling device serves to request the operator person to carry out a specific activity at the treatment module (for example by issuing treatment instructions) or signalling this, such as the sequence of the kegs during cleaning/filling. In this case, instead of an automatic loading device for delivering/removing the kegs, only one instruction for manual work is issued to an operator person, possibly supported by a lifting aid.

In the treatment modules, or by means of the feed device, if required further treatment steps are to be carried out, such as drawing a cap off the fitting of the keg before the treatment, or placing it after the treatment, providing a label or ink-jet printing directly onto the outer wall of the keg, the tightening of the keg fitting, the turning of the keg, in particular by the feed device, and the screening out of bad kegs (which, for example, are defective or so dirt contaminated that they are no longer able to be cleaned). If the kegs are delivered the wrong way round when fed in, an automated turning procedure can be programmed in the feeding device. As an alternative, the turning of the kegs can also be carried out by the holding device of the treatment module.

The cleaning can further comprise an interior cleaning and an outer cleaning. For the interior cleaning of the keg, provision can also be made for preliminary cleaning without additional effort and expenditure on technical apparatus, inasmuch as, for example, a keg can be filled with alkali, in particular by a treatment module, and then placed on a pre-cleaning location, in which the alkali can take effect for a time without a treatment module being occupied 11 during this period. This also serves to optimise the treatment procedures. The keg can be brought from the treatment device to the pre-cleaning location either by the feeding device or by an operator person, and, after the period of taking effect, can be transported back again from the pre-cleaning location to the treatment system. This can be done under instruction from the signalling device. After the pre-cleaning, the actual interior cleaning of the keg can then be carried out, and then the filling in the treatment module.

According to a further advantageous and particularly preferred embodiment variant, at least one of the treatment modules of the system is equipped with a special multifunctional treatment head, which is configured both for internal cleaning as well as for filling the keg. The special treatment head comprises in this case a treatment head housing and at least one plunger, which can be moved in the treatment head housing such as to move in the axial direction of a treatment head axis in the treatment head housing, for the opening of the keg fitting of the keg which is to be treated and is arranged in a sealing position at the treatment head. Formed in the treatment head are at least one fluid space, and, communicating with this in a controlled manner, are flow paths or channels, wherein, when the keg fitting is opened, the flow paths or channels can be connected in a controlled manner to the interior of the keg which is to be treated. For example, at least two flow paths or channels are formed in the treatment head, wherein the first flow path or channel can be subjected to the filling product in a controlled manner, and wherein the second flow path or channel serves to discharge in a controlled manner at least one treatment medium out of the interior of the keg and/or for the controlled delivery of at least one treatment medium into the interior of the keg, and can extend at least partially through the plunger.

The treatment head provided comprises in this situation at least one first controllable media valve, assigned to the fluid space, which is connected to a filling product delivery line and is configured as a product valve for the controlled delivery of a filling product, in particular a beverage, into the interior of the keg which is to be treated. Also provided is a second controllable media valve, which serves as a return valve. For very particular preference, at least the first media valve, serving as a product valve, and preferably also the return valve, comprise a multiple sealing arrangement for the multiple sealing of the filling product delivery system against the fluid space. For the controlling and/or monitoring of the media valves, provision is made for a controlling and/or monitoring unit which is in communicating connection with the media valves.

By means of the multiple sealing arrangement of the first media valve, advantageously at least one security or leakage space is formed, which can preferably be flushed by means of a flushing device, in particular by means of a flushing valve or satellite valve, and/or a controlled discharge, and which, in at least one first closed valve position of the first media valve, forms a separated intermediate space between the fluid space and the filling product delivery system, with the result that a secure separation of the treatment or cleaning media from the filling product is ensured at all times, in particular throughout the entire cleaning and filling process. The multiple sealing arrangement of the first media valve is formed in this situation preferably by a double-seat valve or double-seal leakage valve.

For very particular preference, several treatment modules of the system, in particular all the treatment modules of the system which are configured for the interior cleaning and filling of the kegs, are equipped with the special multifunctional treatment head described above, which is provided with the corresponding multiple sealing arrangement described. Advantageously, at least one of the treatment module, and preferably each of the treatment modules, is capable of interrupting a filling or cleaning process at any desired point of time of the process. This allows, in particular at the cleaning of kegs, for increased flexibility of the system, in particular since in this way different times can be obtained for the taking effect of the cleaning medium, such as an alkali, for the individual kegs.

Preferably, the point of time and/or the duration of the time interruption of the filling or cleaning process can be adjusted and set by the controller, as a dependency of the information on the data carriers which is read out by the reading device.

During the time interruption, the keg can either remain in the treatment module, or, for the purpose of intermediate storage/processing, can be removed from the treatment module and, for example, taken to a holding location provided for this purpose. The interruption of the filling or cleaning process can be used to carry out another treatment on the keg, such as exterior cleaning.

Instead of the kegs being moved in the known manner by transporters past function devices, such as printers for printing a keg, cappers for placing a cap on a keg fitting, cap removers for removing a cap from a keg fitting, and/or label applicators, according to the invention they are preferably moved by the feed device past the function devices, wherein these are arranged in such a way that they lie on the travel path of a gripper arm of the feed device. As a result, separate transporters can be done away with, and the actuation path which is still provided of the gripper arm of the actuation device is additionally used in order to carry out the different functions of the function devices at the keg, without diversions and therefore time-optimised. In this situation, provision can be made for the loading robot to stop briefly at the respective function device in order for the function device to carry out its intended treatment on the keg. It is obvious to the person skilled in the art that the embodiments described heretofore can be combined with one another in any desired manner.

An exemplary embodiment of the invention is described hereinafter on the basis of drawings. The Figures show:

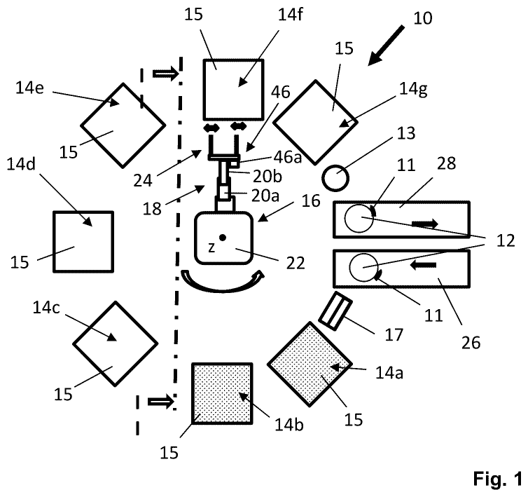

FIG. 1 A view from above onto a container treatment system for kegs, with five treatment modules,

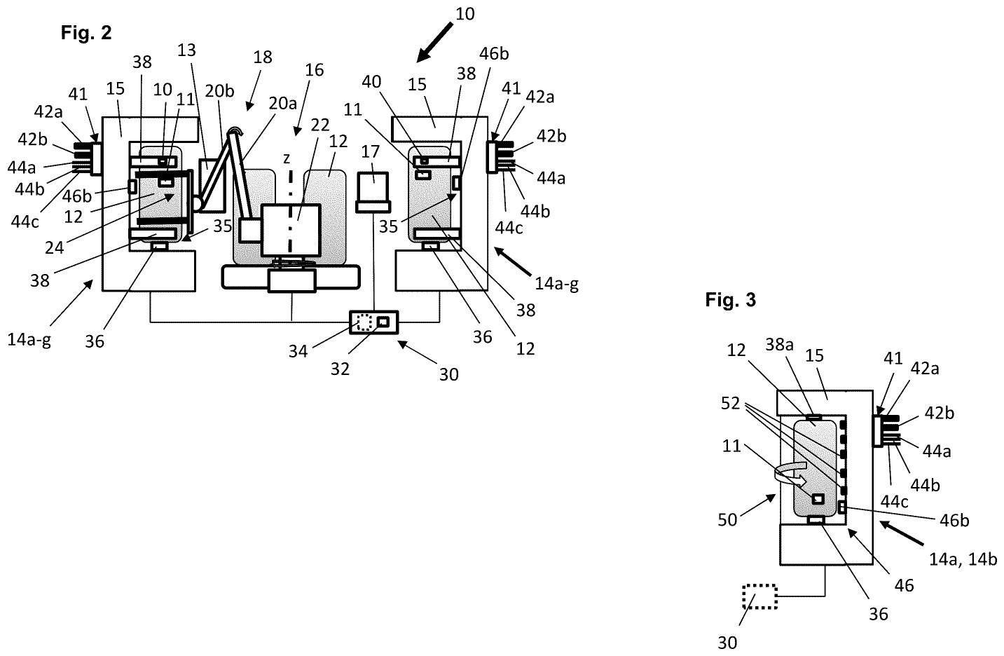

FIG. 2 a view II-II from FIG. 1, leaving out the treatment modules arranged at an angle,

FIG. 3 a treatment module with additional external cleaning device for the keg, and

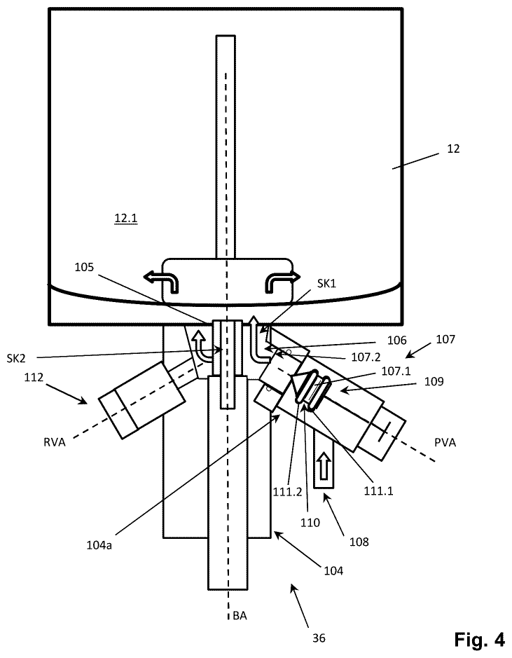

FIG. 4 a rough schematic representation of an exemplary treatment head of an exemplary embodiment variant, with a keg partially represented.

FIGS. 1 and 2 show a keg treatment system 10 for cleaning and filling kegs 12, which comprises a data carrier on which individual data of the keg is stored. The treatment system 10 comprises seven container treatment modules 14a-14g, which are arranged in a circle around a loading robot 16. which in this case forms a feed device. It is of course also possible for a linear feed device and/or a linear arrangement of container treatment modules. A multi-storey arrangement of the container treatment modules is also possible.

The loading robot 16 comprises a basic body 22 which can be rotated about a vertical axis z, which carries a gripper arm 18 which moves through several degrees of freedom. The gripper arm 18 comprises a first arm section 20a for securing to the basic body 22 of the robot 16, a second arm section 20b, which is arranged on the first arm section 20a in a jointed arrangement, at the free end of which there is arranged in turn, in a jointed manner, a gripper 24, which is capable of gripping a keg 12 from a delivery belt 26 and conveying it to each of the container treatment modules 14a-14g, as well as taking it from there and conveying it to a discharge belt 28, from which the kegs 12 which have been treated, in particular cleaned and filled, are again transported away.

Also arranged in the vicinity of the gripper is a first reading unit 46a of a reading device 46, which is capable of reading the data on the data carriers 11 of the kegs 12, and writing it if appropriate.

As an alternative or in addition, arranged at the loading robot 16 is a signalling device in the form of a display 17, on which display is shown which treatment procedure is to be carried out or is being carried out at the individual treatment modules 14a-g. If a loading robot is not provided for, the display serves to guide the operator person in order to ensure optimised cleaning and filling at the treatment modules 14a-g. In addition, arranged in the travel path of the gripper arm 18 of the loading robot 16 is a function device 13, such as, for example, a printer, a capper, a cap remover, a label applier, or the like. In this way it is possible, without making any major changes to the travel path of the gripper arm 18, for a label to be applied, printing carried out, and fitting and removing a cap onto and from the fitting of the keg 12, all integrated into the treatment sequence.

FIG. 2 also shows a common controller 30, which is connected both to the display 17, to the loading robot 16, and also to each treatment module 14a-g. As an alternative, it is possible to use decentralised control modules which are networked to one another. The controller 30 is capable, in a manner described in greater detail hereinafter, by means of the reading units 46a,b of the reading device 46, to read out the individual data carriers 11 at the kegs, and to control the treatment sequence of the kegs 12 in the system 10 as a dependency of the information which is read in.

The controller 30 also contains a work plan memory 32 for cleaning and filling orders of the treatment system 10 which are to be carried out, and a computer module 34, which is configured, on the basis of the filling orders present in the work plan memory 32, to control in an optimum manner, both the display 17 and the loading robot 16, as well as each of the treatment modules 14a-14g.

All the treatment modules 14a-14g have in common that they are preferably provided with a combined cleaning/filling head 36, which is capable of both filling the keg 12 as well as cleaning it from the interior. In addition to this combined cleaning and filling option of each treatment module 14a-g, the first two treatment modules 14a and 14b also have an exterior cleaning function (FIG. 3), which allows for the kegs to be cleaned on the outside, i.e. for the outer wall of the keg 12 to be cleaned. As an alternative, provision can be made for the first two treatment modules 14a and 14b to have only the external cleaning function, while all the other treatment modules 14c-14g perform the cleaning and filling function on the basis of the combined cleaning/filling head 36.

The loading robot 16 can be rotated about a central axis z, which is located in particular in the centre of the treatment modules 14a-14g, arranged in a circle. This is advantageous, since as a result the distance interval of each treatment module 14a-14g from the loading robot 16 is identical, which simplifies the calculation and optimisation of the feeding and discharge paths.

Each treatment module 14a-g has a receiver 35 and a holding device 38 for the keg, arranged at which is a temperature sensor 40 for the degree of filling.

The reading device 46 further contains, in addition to or as an alternative to the first reading unit 46a, at the gripper 24 of the loading robot 16 at each treatment module 14a-g, in each case a further reading unit 46b for the data carrier 11 arranged at the keg 12. Each reading unit 46a,b of the reading device can be, for example, a reading unit for an RFID transponder, which preferably is also capable of partially overwriting the data carrier 11 of the keg 12. In this way, current filling data can be written onto the data carrier 11. In this situation, preferably, ID data of the keg 12 cannot be overwritten.

The controller 30 is configured such as to control and/or regulate a treatment of the kegs 12, in particular cleaning and/or filling, in the respective treatment module as a dependency of the information read out by means of the reading device.

The system 10 therefore allows the duration and/or the intensity or the steps of a treatment to be controlled as a dependency of information which is present from a data carrier 11 arranged in connection with the keg 12. Such information can comprise the filling date and the type of the last filling product, the final recipient, the address data, etc., and therefore allows the controller to assess what treatment the keg 12 requires in order to ensure optimised cleaning and filling.

In particular, in this situation the controller 30 is configured such as to control the duration and/or intensity of the treatment, in particular the cleaning and/or filling, by the respective treatment module, as a dependency of the information on the data carriers read out by the reading device, in order to ensure a rapid and effective treatment sequence of the kegs 12 in the system 10.

The holding device 38a of the keg 12 in the treatment module 14a-g can, as an alternative, also engage the base of the keg 12 from above, which is shown, for example in FIG. 3 by way of the treatment modules 14a, 14b. The keg 12 is held in its identical cleaning and filling position in an upside down position in the receiver 35 of the treatment module 14a-g, such that the fitting of the keg 12 can be connected from below to the combined cleaning/filling head 36.

Each treatment module 14a-14g can be connected via a supply interface 41, which comprises several filling product connections 42a,b, to several product lines, which then makes it possible for different filling products to be filled simultaneously in the treatment system. Moreover, the filling product of a treatment module can be changed after each keg 12. In addition, each treatment module 14a-14g is connected via the supply interface 41 to media lines, in the present case a water connection 44a, a water vapour/steam connection 44b, and a cleaning media connection 44c of the supply interface 41. It is of course possible for other lines, such as a tension gas line, a CO₂ line, etc. to be connected to the supply interface 41. Not represented in the drawing is a waste water discharge line of the treatment module. By means of this supply interface 41 of each treatment module 14a-14g, it is possible for different treatment steps to be carried out simultaneously in the container treatment system 10, such as cleaning and filling, as well as the filling of different filling products. Even with a relatively small system, with only two container treatment modules, this still allows for a high degree of flexibility, since both the control of the different treatment processes, such as filling and interior cleaning, as well as the filling of different filling products, in accordance with the filling orders present in the work plan memory 32, is possible even for very small batches, down to one single keg. This system is therefore very well-suited for the dynamic treatment of kegs in smaller and medium sized filling operations.

Optionally, the first two container treatment modules 14a and 14b have an external cleaning system for the keg 12, as is shown in FIG. 3. Accordingly, the keg receivers 35 of the first two container treatment modules 14a,b are enclosed, for example by a Plexiglas housing, a metal housing, or a glass cover, in order to allow for the spraying of the outer wall with a high-pressure jet and/or steam pressure jet, without putting the surrounding area at risk. For this purpose, the keg receiver 35 is surrounded in particular by a cladding, for example of stainless steel or a Plexiglas housing 50. High-pressure spray nozzles 52 are arranged at the frame 15 of the first two treatment modules 14a,b. In addition to this, the keg is held from above in a rotatable manner by a base holding device 38a, such that all the sides of the outer wall of the keg 12 can be cleaned effectively. The Plexiglas housing 50 can be moved by means of the controller 30 between a release position and a working position, and the spray nozzles 52 can likewise be actuated by means of the controller 30. The first two container treatment modules 14a,b can exhibit this outer wall cleaning option either together with the already present filling and internal cleaning option of conventional cleaning/filling heads 36, or only the first two treatment modules 14a and b are configured for external cleaning, and the internal cleaning and filling then takes place after the external cleaning in the five further treatment modules 14c-14g.

The reading units 46a,b of the reading device 46 can be arranged not only at the gripper 24 or at the treatment module 14a-g, but at any other part of the treatment system 10 which comes into proximity with the data carriers 11 of the kegs 12. The individual data of the keg 12 which is read in via the reading device 46, such as the filling location and filling product, can be used, for example, directly or indirectly, for determining its degree of dirt contamination.

This data of the keg 12 can also be stored in a memory of the controller 30 and used, for example, for reference purposes, such as at which customer the keg was last located, the empty weight value, what product was last filled, how long the keg was with the customer, how long it has been transported or stored, etc. By means of this data, it is also possible to derive conclusions in the future with regard to the degree of dirt contamination, and use this, by means of the controller, to adjust and set an individual cleaning time for each keg 12.

As well as this, i.e. as an alternative or in addition, the dirt contamination can also be determined by measuring the weight of the keg. These features allow the controller 30 to adjust the duration of the cleaning process individually for each single keg 12. As an alternative, the dirt contamination can further be detected by means of a vibration sensor applied to the outer wall of the keg, since the degree of dirt contamination is reflected by the vibration behaviour of the keg.

The controller 30 can also take account accordingly, in its implementation of cleaning and filling orders, of the individual cleaning times of different treatment modules 14a-14g, such as have been detected, for example, by the reading device 46. In this way, a highly effective and rapid container treatment can be provided for small and medium-sized filling operations, including external cleaning, internal cleaning, and filling.

The controller 30 is preferably formed by a microprocessor controller.

With reference to FIG. 4, solely by way of example on the basis of a possible embodiment shown only as an example, a treatment head 36 is described, such as can be used, for example, in at least one of the treatment modules 14a-g. The preferred treatment head 36, shown by way of example, is a special multifunctional treatment head 36 for the internal cleaning and filling of kegs 12.

The treatment head 36, comprising a treatment head housing 104, has a plunger 105, which is accommodated at least in part in a cavity space of the treatment head housing 104, and is held in the treatment head housing 104 in such a way that it can be moved in the axial direction of a treatment head axis BA, and, on its being moved, can open the keg fitting of the keg 12 which is to be treated and is arranged in a sealing position at the treatment head 36. The cavity space in the treatment head housing 104 further forms, at least in part or at least in sections, a fluid space 106, as well as flow paths or channels SK1, SK2 which communicate in a controllable manner with the fluid space 106, and which, with the keg fitting open of a keg 12 arranged in a sealing position at the treatment head 36, can be connected in a controlled manner with the interior 12.1 of the keg 3. For example, the interior 2.1 of the keg 3 can be filled with the filling product by way of the first flow path or channel SK1. The second flow path or channel SK2 serves to discharge in a controlled manner at least one treatment medium out of the interior 12.1 of the keg 12 and/or for the controllable delivery of at least one treatment medium into the interior 12.1 of the keg 12. The second flow path or channel SK2 can extend at least in part through the plunger 105.

Also provided at the treatment head 36 are media valves 107, 112, assigned to the fluid space 106, and specifically one first controllable media valve 107, serving to provide controlled delivery of the filling product, which can be connected to a filling product delivery line 108, and a second controllable media valve 112, serving as a return valve. Each of the media valves 107, 112 extends along a respective valve axis, and, specifically, the product valve 107 along a product valve axis PVA and the return valve 112 along a return valve axis RVA. The media valves 107, 112 connect to a respective valve housing section 104a at a transition section or valve transition section of the treatment head housing 104. The valve housing section 104a can be, for example, an integral part of the treatment head housing 104, and configured as being of one piece with it.

At least with the first controllable media valve 107, serving as the product valve, a valve body 107.1 is provided, which is at least partially accommodated in the valve housing section 104a or is at least partially projecting into the valve housing section 104a, and which can be moved in the direction of the product valve axis PVA. An actuator drive is provided for the movement of the valve body 107.1 along the product valve axis PVA. Formed in the interior in the valve housing section 104a is a valve seat 107.2, against which the valve body 107.1 is in sealing contact, in the region of a front valve body end, at least in one of its extreme positions, namely in a closed position or a first closed valve setting.

In its other extreme position, namely the open position, shown in FIG. 4, the valve body 107.1 is located at a distance from the valve seat 107.2, as a result of which a flow path for the filling product is cleared, inasmuch as, in this valve setting, the filling product delivery line 108 is in fluidic connection with the fluid space 106 and, connected to this, the first flow path or channel SK1. The controlling and/or monitoring of the media valves 107, 112, is carried out by means of the control unit and/or monitoring unit, which, among other functions, also controls and monitors the valve settings and positions and the switching of the valves.

With the multifunctional treatment head 36 shown, the product valve 107 comprises a multiple sealing arrangement 109 for the multiple sealing of the filling product delivery line 108 against the fluid space 106, in order to ensure a secure separation between filling product and cleaning media or cleaning means. By means of the multiple sealing arrangement 109, which in the example represented is formed by a double-seat valve or double-seal leakage valve, and comprises a first sealing element 111.1 and a second sealing element 111.2, a security or leakage space 110 is formed, which can be flushed, and which, in the first closed valve setting of the product valve 107 forms a separated intermediate space between the fluid space 106 and the filling product delivery line 108, and, as a result, separates and seals the filling product delivery line 108 and the fluid space 106 against one another reliably and preferably completely, as well as advantageously sealing them against one another.

Hereinafter the cleaning and filling process are described, in basic details and on the basis of an exemplary sequence, as to how it can be carried out in an exemplary treatment module 14a-g, which is equipped with the exemplary treatment head 36 described.

An empty keg 12, which is to be treated, is introduced into the treatment module 14a-g, and positioned there in such a way that the keg 12 moves with its keg fitting into a sealing position with the treatment head 36 and is pressed against it. In order to set the interior cleaning process in motion, the keg fitting 2 is opened by means of the plunger 105, such that the individual internal cleaning steps can be carried. During the internal cleaning, in each of the individual sequential cleaning steps, in each case a cleaning medium is delivered by way of the treatment head 36, and discharged again by way of the second controllable media valve 112 of the treatment head 36, serving as a return valve. During the entire internal cleaning, the product valve 107, connected to the filling product delivery line 108, is held in its closed valve position, in which the fluid space 106 and the filling product delivery line 108 are separated securely and double-sealed against one another by means of the security or leakage space 110 formed by the multiple seal arrangement 109.

After the internal cleaning steps for the cleaning of the interior 12.1, the first media valve 107 is brought in a controlled manner into a middle valve setting, which takes effect as an intermediate or flushing position, in order to carry out a flushing of the head and dead space, with flushing of the security or leakage space 110. By means of a flushing device, preferably provided at the security or leakage space 110 (but not represented in the Figures), in particular by means of a flushing valve, also designated as a satellite valve, and/or by means of a controlled discharge to the outside, the flushing and secure emptying of the security or leakage space 110 can take place in a controlled manner, in order to hold it open or closed as required. After this flushing of the head or dead space, for the actual filling of the keg 13, the first media valve 107 is brought into the filling position and filling product is delivered, until, upon the reaching of the desired filling level, the filling step is stopped by the closing of the first media valve 107.

It is clear to the person skilled in the art that the exemplary embodiment represented is not to be understood as restrictive, but rather that the invention can be put into effect within the entire scope of protection of the appended claims.

### REFERENCE NUMBER LIST

10 Keg treatment system
11 Data carrier at the keg, in particular a passive RFID transponder
12 Keg
12.1 Interior of the keg
13 Function device (e.g. printer, capper, cap remover, label applier, etc.)
14a-g Treatment module with combined cleaning and filling function
14a,b Treatment module with additional exterior cleaning function
15 Frame of the cleaning module
16 Loading robot
17 Signalling device-display/LED/buzzer
18 Gripper arm of the loading robot
20a First arm section
20b Second arm section
22 Basic body of the loading robot, rotatable about a vertical axis of rotation z
24 Gripper of the loading robot
26 Delivery belt
28 Discharge belt
30 Controller
32 Work plan memory
34 Computer module
35 Receiver—keg receiver of the treatment module
36 Treatment head or combined cleaning/filling head
38 Holding device engaging around the keg
38a Base holding device for the keg
40 Temperature sensor
41 Supply interface
42a,b Filling product connections
44a Water connection
44b Water vapour/steam connection
44c Cleaning media connection
46 Reading device
46a First reading unit of the reading device
46b Further reading unit of the reading device
50 Plexiglas housing
52 Spray nozzles for external cleaning
104 Treatment head housing
104a Valve housing section
105 Plunger
106 Fluid space
107 First controllable media valve
107.1 Valve body
107.2 Valve seat
108 Filling product delivery line
109 Multiple seal arrangement
110 Security or leakage space
111.1 First sealing element
111.2 Second sealing element
112 Second controllable media valve
BA Treatment head axis
PVA Product valve axis
RVA Return valve axis
SK1, 2 First and second flow path or channel
Z Vertical axis of rotation of the loading robot

1-22. (canceled)

23. A system for treating kegs having data carriers, the system comprising:
at least one treatment module having,
a keg receiver configured for receiving at least one keg,
a treatment head configured for treating the keg, and
at least one interface for a discharge line, and for at least one cleaning medium line and/or at least one filling product line,
at least one signaling device for signaling activities which are to be carried out in conjunction with the treatment modules, and/or at least one loading device for delivering and discharging the kegs to and from the individual treatment modules;
a controller for controlling the at least one treatment module, and for controlling the signaling device and/or the loading device;
a reading device connected to the controller for reading the information deposited on the data carrier, and said controller being configured to carry out a treatment of the kegs, based on the information deposited on the data carrier read by the reading device.

24. The system according to claim 23, wherein the controller is configured to control a duration and/or an intensity of the treatment by each of the at least one treatment module based on the information deposited on the data carrier read by the reading device.

25. The system according to claim 23, wherein the system has a loading device, and the reading device has a first reading unit at the loading device, and the reading device is configured to read the information deposited on the data carriers while the kegs are transported by the loading device to the at least one treatment module.

26. The system according to claim 25, wherein a further reading unit of the reading device is arranged at or in the at least one treatment module.

27. The system according to claim 23, wherein:
the at least one treatment module is a plurality of treatment modules;
the reading device has a plurality of reading units corresponding to the plurality of treatment modules, and each reading unit is arranged at or in the respective treatment modules; and
the plurality of reading units are configured for reading the information deposited on the data carriers;

28. The system according to claim 23, wherein the reading device is configured to read the information deposited on the data carriers while the kegs are in the at least one treatment module.

29. The system according to claim 23, wherein the reading device is configured to read the information deposited on the data carriers using radio waves.

30. The system according to claim 23, wherein the reading device is formed as a combined writing and reading device, and the reading device is configured to write information onto the data carriers and/or into a databank.

31. The system according to claim 30, wherein
the reading device is configured to write information provided by the controller onto the data carrier and/or into the databank after the treatment in the at least one treatment module.

32. The system according to claim 23, wherein the reading device is configured as an RFID reading device, and the data carriers are configured as RFID transponders.

33. The system according to claim 23, wherein the at least one treatment module is a plurality of treatment modules, and the treatment head of at least one of the plurality of treatment modules is configured for both filling the keg with a filling product and for cleaning the interior cleaning of the keg.

34. The system according to claim 23, wherein the at least one treatment module is a plurality of treatment modules, and at least one of the plurality of treatment modules has a device configured for the external cleaning of the keg.

35. The system according to claim 23, further comprising at least one external cleaning module for the external cleaning of the kegs, wherein the system has a loading device, and the loading device is configured for the delivery and removal of the kegs to and from the external cleaning module.

36. The system according to claim 23, wherein the keg receiver of the at least one treatment module is configured for the static receiving of one or more kegs.

37. The system according to claim 23, wherein the at least one treatment module is a plurality of treatment modules, and the keg receiver of at least one of the plurality of treatment modules is configured to receive one single keg.

38. The system according to claim 24, wherein the controller has at least one data memory for individual data of the keg, and the controller is configured to control the duration of the treatment, in the at least one treatment module based on the individual data.

39. The system according to claim 23, wherein the system has a loading device, and the controller is configured to calculate a delivery and discharge path of each keg and to carry out the movement of the loading device based on an optimization criterion.

40. The system according to claim 39, wherein the optimization criterion has a criterion for the optimization of at least one of the path, time, and energy.

41. The system according to claim 23, wherein the at least one treatment module is a plurality of treatment modules, the interface of at least two of the plurality of treatment modules has connections to at least two filling product lines, and the controller is configured to operate at least one of the at least two of the plurality of treatment modules with a first filling product, and at least one other of the at least two of the plurality of treatment modules with a second filling product.

42. The system according to claim 23, wherein the controller has a work plan memory for filling and/or cleaning orders to be carried out, and the controller has a computer module configured to control the at least one treatment module based on the cleaning and/or filling orders.

43. The system according to claim 42, wherein the computer module of the controller is configured to control the at least one treatment module, and the signaling device and/or the loading device, so that the processing of the cleaning and/or filling orders is based on at least one of the following optimization criteria:
time optimization,
optimization of the filling and/or cleaning capacity,
energy optimization,
optimization of the actuation paths of the feed device, and
minimization of the cleaning effort and/or cleaning media consumption.

44. The system according to claim 23, wherein:
the at least one treatment module is a plurality of treatment modules, and the plurality of treatment modules are configured for the treatment of different kegs; and
at least one of the plurality of treatment modules is configured for the treatment of kegs of a first type, and at least one other of the plurality of treatment modules is configured for the treatment of kegs of a second type.
